(19) United States
(12) Patent Application Publication
(10) Pub. No.: US 2015/0194807 A1
(43) Pub. Date: Jul. 9, 2015

(54) SURGE PROTECTION CIRCUIT

(71) Applicant: ZTE CORPORATION, Shenzhen City, Guangdong (CN)

(72) Inventors: Zhenghai Wan, Shenzhen City (CN); Junkai Li, Shenzhen City (CN); Xifeng Pu, Shenzhen City (CN); Dan Li, Shenzhen City (CN)

(21) Appl. No.: 14/413,604

(22) PCT Filed: Aug. 16, 2013
(86) PCT No.: PCT/CN2013/081672

§ 371 Date: Jan. 8, 2015

(30) Foreign Application Priority Data
Nov. 12, 2012 (CN) 201210453846.1

(51) Int. Cl. H02H 9/04; H02H 9/00

(52) U.S. Cl. CPC H02H 9/044; H02H 9/005

(57) ABSTRACT

A surge protection circuit includes a bridgeless boost sub-circuit and a surge protection sub-circuit. The bridgeless boost sub-circuit includes a first connection end and a second connection end of an alternating current power source, an inductor 1, an inductor 2, a switching tube 1 with a damping diode, a switching tube 2 with a damping diode, a capacitor, a diode 5, and a diode 6. The surge protection sub-circuit includes a first connection end and a second connection end of an alternating current power source, a diode 1, a diode 2, a transistor 3, a transistor 4, and a surge buffer device. In such a fashion, a surge buffer device is used to absorb a surge current, and the surge buffer device is not in a main topology circuit.

### TECHNICAL FIELD

The present invention relates to the field of the input surge technology of switching power source, and in particular, to a surge protection circuit.

### BACKGROUND OF THE RELATED ART

The modern mobile communication technology is being developed forward with a unprecedented speed, and the communication base station essential for the modern communication is easy to be influenced by the abominable external conditions (such as, the weather and the geographical position, etc.); and the communication power supply that supplies power for the communication base station will be influenced by these factors as well, so the design of the surge protection system is required to be performed when designing the communication power supply, to try hard to reduce the harmful influence brought by the lightning surge to the communication power supply. FIG. 1 and FIG. 2 are the surge protection circuits of the traditional boost circuit and the bridgeless boost circuit respectively. The surge protection circuit of FIG. 1 and FIG. 2 mainly utilizes the capacitor C1 to absorb the surge current, and the capacity of the capacitor C1 is required to be relatively large.

### CONTENT OF THE INVENTION

The embodiment of the present invention provides a surge protection circuit, to provide a new solution for the surge protection.

The embodiment of the present invention provides a surge protection circuit, comprising a bridgeless boost sub-circuit and a surge protection sub-circuit, wherein,
the bridgeless boost sub-circuit comprises a first connection end and a second connection end of an alternating current power source, an inductor 1, an inductor 2, a switching tube 1 with a damping diode, a switching tube 2 with a damping diode, a capacitor 1, a diode 5, and a diode 6; one end of the inductor 1 is connected to the first connection end of the alternating current power source, another end of the inductor 1 is connected to a positive pole of the diode 5 and a negative pole of the switching tube 1 with the damping diode, one end of the inductor 2 is connected to the second connection end of the alternating current power source, another end of the inductor 2 is connected to a positive pole of the diode 6 and a negative pole of the switching tube 2 with the damping diode, one end of the capacitor 1 is connected to a negative pole of the diode 5 and a negative pole of the diode 6, and another end of the capacitor 1 is connected to a positive pole of the switching tube 1 with the damping diode and a positive pole of the switching tube 2 with the damping diode;
the surge protection sub-circuit comprises a first connection end and a second connection end of an alternating current power source, a diode 1, a diode 2, a transistor 3 and a transistor 4; a positive pole of the diode 1 is connected to the first connection end of the alternating current power source, a positive pole of the diode 2 is connected to a second connection end of the alternating current power source, a negative pole of the transistor 3 is connected to the first connection end of the alternating current power source, and a negative pole of the transistor 4 is connected to the second connection end of the alternating current power source; and
the surge protection sub-circuit further comprises a surge buffer device, one end of the surge buffer device is connected to a negative pole of the diode 1 and a negative pole of the diode 2, and another end of the surge buffer device is connected to a positive pole of the transistor 3 and a positive pole of the transistor 4.

Alternatively, the above-mentioned circuit further can have the following characteristics:
both the switching tube 1 with the damping diode and the switching tube 2 with the damping diode are N channel metal oxide semiconductors (MOS) tube with the damping diodes.

Alternatively, the above-mentioned circuit further can have the following characteristics:
the surge buffer device is a capacitor 2 and a resistance 2 which are parallel.

Alternatively, the above-mentioned circuit further can have the following characteristics:
the surge buffer device is a piezoresistor.

Alternatively, the above-mentioned circuit further can have the following characteristics:
the transistor 3 and the transistor 4 are diodes.

Alternatively, the above-mentioned circuit further can have the following characteristics:
the transistor 3 and the transistor 4 are switching tubes with the damping diodes.

Alternatively, the above-mentioned circuit further can have the following characteristics:
the switching tube with the damping diode is a N channel MOS tube with the damping diode.

Alternatively, the above-mentioned circuit further can have the following characteristics:
the transistor 3 and the transistor 4 are Insulated Gate Bipolar Transistors (IGBT) with the damping diodes.

The embodiment of the present invention further provides a surge protection circuit, comprising a surge protection sub-circuit, wherein,
the surge protection sub-circuit comprises a first connection end and a second connection end of an alternating current power source, a diode 1, a diode 2, a transistor 3 and a transistor 4; a positive pole of the diode 1 is connected to the first connection end of the alternating current power source, a positive pole of the diode 2 is connected to a second connection end of the alternating current power source, a negative pole of the transistor 3 is connected to the first connection end of the alternating current power source, and a negative pole of the transistor 4 is connected to the second connection end of the alternating current power source; and
the surge protection sub-circuit further comprises a surge buffer device, one end of the surge buffer device is connected to a negative pole of the diode 1 and a negative pole of the diode 2, and another end of the surge buffer device is connected to a positive pole of the transistor 3 and a positive pole of the transistor 4.

Alternatively, the above-mentioned circuit further can have the following characteristics:
the surge buffer device is a capacitor 2 and a resistance 2 or a piezoresistor which are parallel; and
the transistor 3 and the transistor 4 are diodes, switching tubes with damping diodes or Insulated Gate Bipolar Transistors (IGBT) with the damping diodes.

In the present scheme, the surge current is absorbed by utilizing the surge buffer device, and the surge buffer device is not in the main topology circuit. For example, when the surge buffer device is the capacitor C2, compared to the C1 in FIG. 1 and FIG. 2, the capacity of the C2 is smaller, and the volume is smaller as well.

### BRIEF DESCRIPTION OF DRAWINGS

FIG. 1 is a structure diagram of a surge protection circuit of a traditional boost circuit;

FIG. 2 is a structure diagram of a surge protection circuit of a bridgeless boost circuit in the related art;

FIG. 3 is a structure diagram of a surge protection circuit according to embodiment one of the present invention;

FIG. 4 is a diagram of a positive surge propagation of a surge protection circuit passing through FIG. 3 according to an embodiment of the present invention;

FIG. 5 is a diagram of a negative surge propagation of a surge protection circuit passing through FIG. 3 according to an embodiment of the present invention;

FIG. 6 is a structure diagram of a surge protection circuit according to embodiment two of the present invention;

FIG. 7 is a structure diagram of a surge protection circuit according to embodiment four of the present invention;

FIG. 8 is a structure diagram of a surge protection circuit according to embodiment five of the present invention.

### PREFERRED EMBODIMENTS OF THE PRESENT INVENTION

The surge protection circuit in the present scheme includes a bridgeless boost sub-circuit and a surge protection sub-circuit.

The bridgeless boost sub-circuit includes a first connection end and a second connection end of an alternating current power source, an inductor 1, that is, L1, an inductor 2, that is, L2, a switching tube 1 with a damping diode, a switching tube 2 with a damping diode, a capacitor 1, that is, C1, a diode 5, that is, D5, and a diode 6, that is, D6; one end of the L1 is connected to the first connection end of the alternating current power source, the other end is connected to a positive pole of the D5 and a negative pole of the switching tube 1 with the damping diode, one end of the inductor 2 is connected to the second connection end of the alternating current power source, the other end is connected to a positive pole of the D6 and a negative pole of the switching tube 2 with the damping diode, one end of the capacitor 1 is connected to a negative pole of the D5 and a negative pole of the D6, and the other end of the capacitor 1 is connected to a positive pole of the switching tube 1 with the damping diode and a positive pole of the switching tube 2 with the damping diode. Wherein, the switching tube 1 with the damping diode and the switching tube 2 with the damping diode can be N channel metal oxide semiconductor (MOS) tubes with the damping diodes.

The surge protection sub-circuit includes a first connection end and a second connection end of an alternating current power source, a diode 1, that is, D1, a diode 2, that is, D2, a transistor 3 and a transistor 4. A positive pole of the D1 is connected to the first connection end of the alternating current power source, a positive pole of the D2 is connected to a second connection end of the alternating current power source, a negative pole of the transistor 3 is connected to the first connection end of the alternating current power source, and a negative pole of the transistor 4 is connected to the second connection end of the alternating current power source.

The surge protection sub-circuit further includes a surge buffer device, one end of the surge buffer device is connected to a negative pole of the D1 and a negative pole of the D2, and the other end of the surge buffer device is connected to a positive pole of the transistor 3 and a positive pole of the transistor 4.

The surge buffer device can be a capacitor 2 and a resistance 2 which are parallel.

The surge buffer device can be a piezoresistor.

The transistor 3 and the transistor 4 can be the diodes. The encapsulations of the diodes in the surge protection sub-circuit can be adjusted, for example, a rectifier bridge or an independently encapsulated diode can be used.

The transistor 3 and the transistor 4 can be the switching tubes with the damping diodes, for example, the N channel MOS tubes with the damping diodes.

It is explained in detail through four embodiments hereinafter.

### Embodiment One

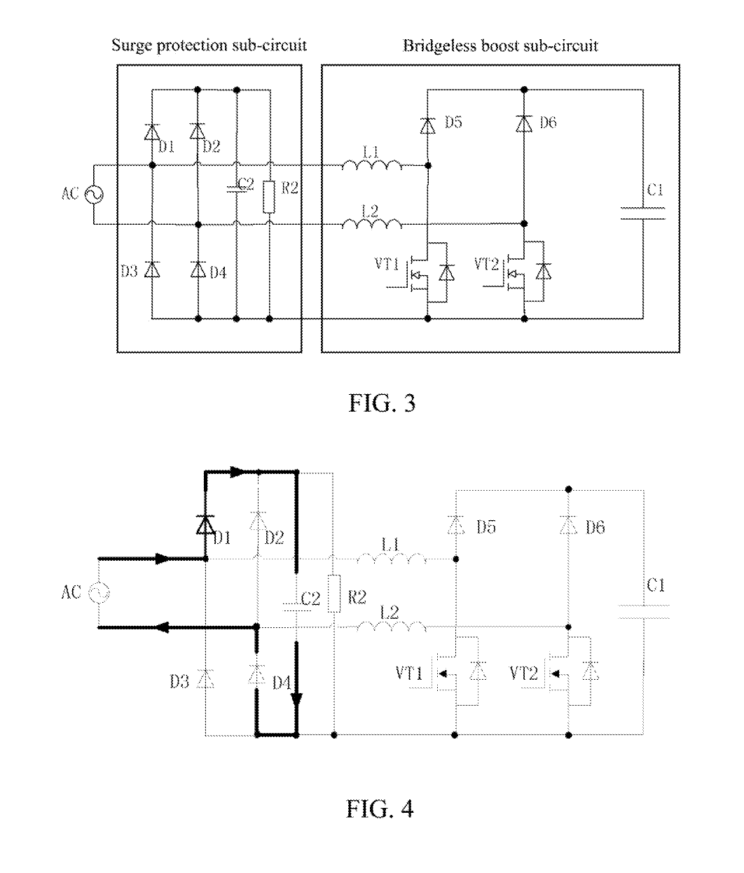

As shown in FIG. 3, the surge buffer device is a filter capacitor C2 and a discharge resistance R2 which are parallel, the transistor 3 is the diode D3, and the transistor 4 is the diode D4. The D3 and the D4 are not only the return pipes of the bridgeless boost sub-circuit but also the surge protection diodes. Through adding the C2 and the R2 which are parallel, the input surge energy is absorbed through the C2 and then discharged through the R2 in the present embodiment. The D1, D2, D3 and D4 can be the rectifier bridge stack, and can also be the independently encapsulated diodes.

When the positive surge current reaches the AC input end, the breakover path of the surge current is as shown in FIG. 4, which avoids that a large amount of surge currents pass through the boost diode and the switching tube in the bridgeless boost sub-circuit in this way, thus playing the function of protecting the device.

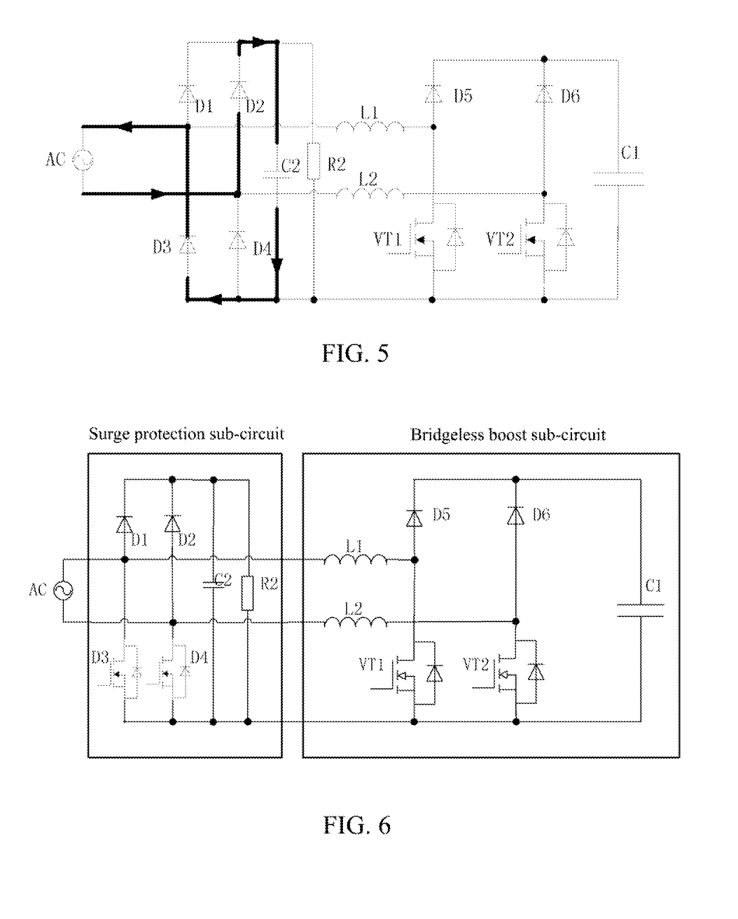

When the negative surge current reaches the AC input end, the breakover path of the surge current is as shown in FIG. 5, which avoids that a large amount of surge currents pass through the boost diode and the switching tube in the bridgeless boost sub-circuit in this way, thus playing the function of protecting these devices.

### Embodiment Two

As shown in FIG. 6, the surge buffer device is the C2 and the R2 which are parallel, and the transistor 3 and the transistor 4 are the N channel MOS tubes with the damping diodes. The operating principle of embodiment two is the same with the embodiment one, and will no longer go into details here.

### Embodiment Three

In embodiment three, the surge buffer device is the C2 and the R2 which are parallel, and the transistor 3 and the transistor 4 are the Insulated Gate Bipolar Transistors (IGBT) with the damping diodes. The operating principle of embodiment three is the same with the embodiment one, and will no longer go into details here.

### Embodiment Four

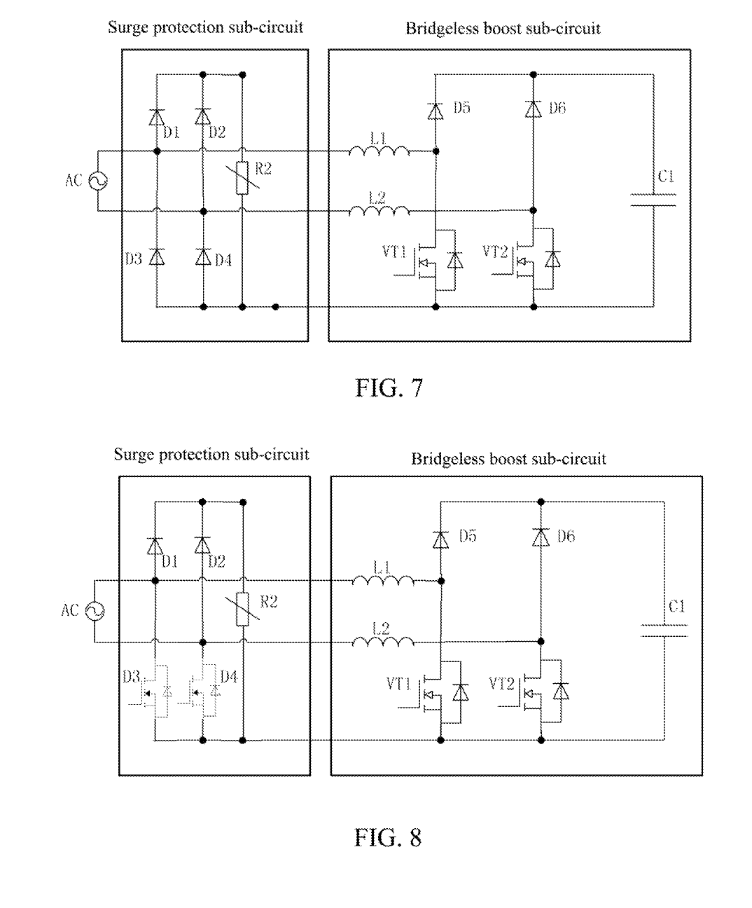

As shown in FIG. 7, the surge buffer device is a piezoresistor, and the transistor 3 and the transistor 4 are the diodes. The piezoresistor plays a role of discharging the energy. The operating principle of embodiment four is the same with the embodiment one, and will no longer go into details here. The D3 and/or the D4 not only serve as the return pipes of the bridgeless boost sub-circuit, but also serve as the surge protection diodes.

### Embodiment Five

As shown in FIG. 8, the surge buffer device is a piezoresistor, and the transistor 3 and the transistor 4 are the N channel MOS tubes with the damping diodes. The operating principle of embodiment five is the same with the embodiment one, and will no longer go into details here.

### Embodiment Six

In embodiment six, the surge buffer device is a piezoresistor, and the transistor 3 and the transistor 4 are the IGBTs with the damping diodes. The operating principle of embodiment six is the same with the embodiment one, and will no longer go into details here.

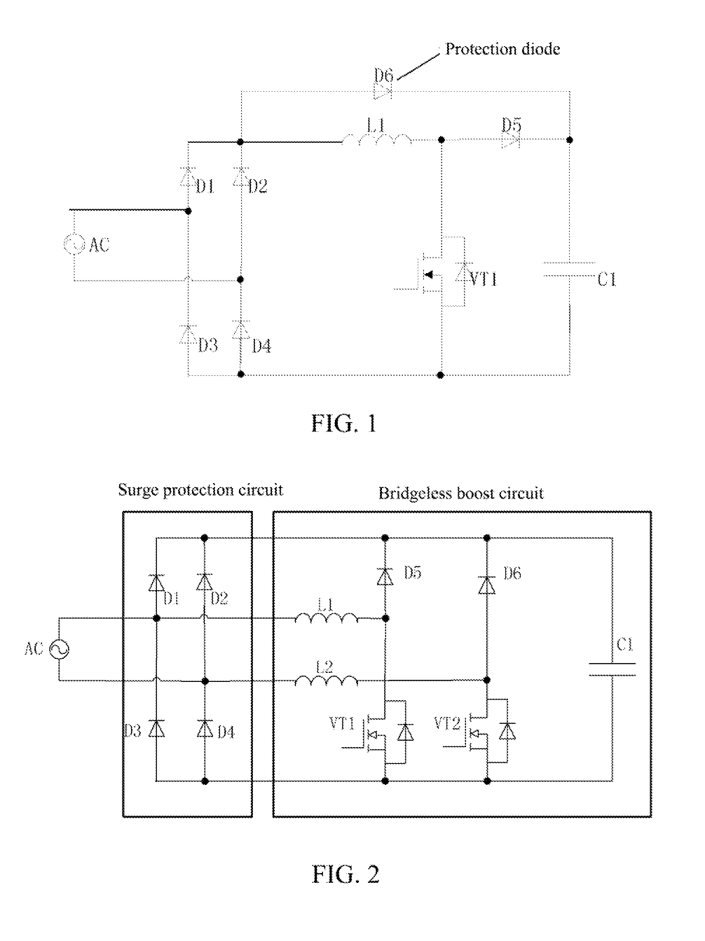

In the present scheme, the surge current is absorbed by utilizing the surge buffer device, and the surge buffer device is not in the main topology circuit. For example, when the surge buffer device is the capacitor C2, compared to the C1 in FIG. 1 and FIG. 2, the capacity of the C2 is smaller, and the volume is smaller as well.

It should be illustrated that, in the case of not conflicting, the embodiments in the present application and features in these embodiments can be combined with each other.

Obviously, the present invention can have a variety of other embodiments. Those skilled in the art can make the corresponding modifications and variations according to the present invention without departing from the spirit and essence of the present invention. And all of these modifications or the variations should be embodied in the scope of the appending claims of the present invention.

It can be understood by those skilled in the art that all or part of steps in the above-mentioned method can be fulfilled by programs instructing the relevant hardware components, and the programs can be stored in a computer readable storage medium such as a read only memory, a magnetic disk or an optical disk, etc. Alternatively, all or part of the steps in the above-mentioned embodiments can be implemented with one or more integrated circuits. Accordingly, each module/unit in the above-mentioned embodiments can be implemented in the form of hardware, or in the form of software function module. The present invention is not limit to any specific form of the combination of the hardware and software.

### INDUSTRIAL APPLICABILITY

In the present scheme, the surge current is absorbed by utilizing the surge buffer device, and the surge buffer device is not in the main topology circuit.

1. A surge protection circuit, comprising a bridgeless boost sub-circuit and a surge protection sub-circuit, wherein,
the bridgeless boost sub-circuit comprises a first connection end and a second connection end of an alternating current power source, an inductor 1, an inductor 2, a switching tube 1 with a damping diode, a switching tube 2 with a damping diode, a capacitor 1, a diode 5, and a diode 6; one end of the inductor 1 is connected to the first connection end of the alternating current power source, another end of the inductor 1 is connected to a positive pole of the diode 5 and a negative pole of the switching tube 1 with the damping diode, one end of the inductor 2 is connected to the second connection end of the alternating current power source, another end of the inductor 2 is connected to a positive pole of the diode 6 and a negative pole of the switching tube 2 with the damping diode, one end of the capacitor 1 is connected to a negative pole of the diode 5 and a negative pole of the diode 6, and another end of the capacitor 1 is connected to a positive pole of the switching tube 1 with the damping diode and a positive pole of the switching tube 2 with the damping diode;
the surge protection sub-circuit comprises a first connection end and a second connection end of an alternating current power source, a diode 1, a diode 2, a transistor 3 and a transistor 4; a positive pole of the diode 1 is connected to the first connection end of the alternating current power source, a positive pole of the diode 2 is connected to a second connection end of the alternating current power source, a negative pole of the transistor 3 is connected to the first connection end of the alternating current power source, and a negative pole of the transistor 4 is connected to the second connection end of the alternating current power source; and
the surge protection sub-circuit further comprises a surge buffer device, one end of the surge buffer device is connected to a negative pole of the diode 1 and a negative pole of the diode 2, and another end of the surge buffer device is connected to a positive pole of the transistor 3 and a positive pole of the transistor 4.

2. The circuit according to claim 1, wherein,
both the switching tube 1 with the damping diode and the switching tube 2 with the damping diode are N channel metal oxide semiconductors (MOS) tube with the damping diodes.

3. The circuit according to claim 1, wherein,
the surge buffer device is a capacitor 2 and a resistance 2 which are parallel.

4. The circuit according to claim 1, wherein,
the surge buffer device is a piezoresistor.

5. The circuit according to claim 1, wherein,
the transistor 3 and the transistor 4 are diodes.

6. The circuit according to claim 1, wherein,
the transistor 3 and the transistor 4 are switching tubes with the damping diodes.

7. The circuit according to claim 6, wherein,
the switching tube with the damping diode is a N channel MOS tube with the damping diode.

8. The circuit according to claim 1, wherein,
the transistor 3 and the transistor 4 are Insulated Gate Bipolar Transistors (IGBT) with the damping diodes.

9. A surge protection circuit, comprising a surge protection sub-circuit, wherein,
the surge protection sub-circuit comprises a first connection end and a second connection end of an alternating current power source, a diode 1, a diode 2, a transistor 3 and a transistor 4; a positive pole of the diode 1 is connected to the first connection end of the alternating current power source, a positive pole of the diode 2 is connected to a second connection end of the alternating current power source, a negative pole of the transistor 3 is connected to the first connection end of the alternating current power source, and a negative pole of the transistor 4 is connected to the second connection end of the alternating current power source; and
the surge protection sub-circuit further comprises a surge buffer device, one end of the surge buffer device is connected to a negative pole of the diode 1 and a negative pole of the diode 2, and another end of the surge buffer device is connected to a positive pole of the transistor 3 and a positive pole of the transistor 4.

10. The circuit according to claim 9, wherein,
the surge buffer device is a capacitor 2 and a resistance 2 or a piezoresistor which are parallel; and
the transistor 3 and the transistor 4 are diodes, switching tubes with damping diodes or Insulated Gate Bipolar Transistors (IGBT) with the damping diodes.

11. The circuit according to claim 2, wherein,
the transistor 3 and the transistor 4 are diodes.

12. The circuit according to claim 2, wherein,
the transistor 3 and the transistor 4 are switching tubes with the damping diodes.

13. The circuit according to claim 12, wherein,
the switching tube with the damping diode is a N channel MOS tube with the damping diode.

14. The circuit according to claim 2, wherein,
the transistor 3 and the transistor 4 are Insulated Gate Bipolar Transistors (IGBT) with the damping diodes.

15. The circuit according to claim 3, wherein,
the transistor 3 and the transistor 4 are diodes.

16. The circuit according to claim 3, wherein,
the transistor 3 and the transistor 4 are switching tubes with the damping diodes.

17. The circuit according to claim 16, wherein,
the switching tube with the damping diode is a N channel MOS tube with the damping diode.

18. The circuit according to claim 3, wherein,
the transistor 3 and the transistor 4 are Insulated Gate Bipolar Transistors (IGBT) with the damping diodes.

19. The circuit according to claim 4, wherein,
the transistor 3 and the transistor 4 are diodes.

20. The circuit according to claim 4, wherein,
the transistor 3 and the transistor 4 are switching tubes with the damping diodes.
